(19) United States
(12) Patent Application Publication
(10) Pub. No.: US 2016/0026102 A1
(43) Pub. Date: Jan. 28, 2016

(54) ELECTROSTATIC CHARGE IMAGE DEVELOPING TONER, ELECTROSTATIC CHARGE IMAGE DEVELOPER, TONER CARTRIDGE, PROCESS CARTRIDGE, AND IMAGE FORMING APPARATUS

(71) Applicant: FUJI XEROX CO., LTD., Tokyo (JP)

(72) Inventors: Emi MIYATA, Tokyo (JP); Soichiro KITAGAWA, Kanagawa (JP); Tomohiro SHINYA, Kanagawa (JP)

(73) Assignee: FUJI XEROX CO., LTD., Tokyo (JP)

(21) Appl. No.: 14/617,418

(22) Filed: Feb. 9, 2015

(30) Foreign Application Priority Data
Jul. 24, 2014 (JP) 2014-151141

(51) Int. Cl. G03G 9/00

(52) U.S. Cl. CPC G03G 9/08755; G03G 9/08733

(57) ABSTRACT

An electrostatic charge image developing toner includes a toner particle including a binder resin containing an amorphous polyester resin and a crystalline polyester resin, wherein a Young's modulus of the toner particles at 20° C. is 3.0 GPa to 3.5 GPa.

### CROSS-REFERENCE TO RELATED APPLICATIONS

This application is based on and claims priority under 35 USC 119 from Japanese Patent Application No. 2014-151141 filed Jul. 24, 2014.

### BACKGROUND

1. Technical Field

The present invention relates to an electrostatic charge image developing toner, an electrostatic charge image developer, a toner cartridge, a process cartridge, and an image forming apparatus.

2. Related Art

As an electrostatic charge image developing toner applicable to an electrophotographic image forming apparatus, various kinds of electrostatic charge image developing toners have been proposed.

### SUMMARY

According to an aspect of the invention, there is provided an electrostatic charge image developing toner including:

a toner particle including a binder resin containing an amorphous polyester resin and a crystalline polyester resin,

wherein a Young's modulus of the toner particles at 20° C. is 3.0 GPa to 3.5 GPa.

### BRIEF DESCRIPTION OF THE DRAWINGS

Exemplary embodiments of the present invention will be described in detail based on the following figures, wherein:

FIG. 1 is a schematic configuration diagram showing an example of an image forming apparatus according to an exemplary embodiment; and

FIG. 2 is a schematic configuration diagram showing an example of a process cartridge according to an exemplary embodiment.

### DETAILED DESCRIPTION

Hereinafter, an exemplary embodiment which is an example of the present invention will be described in detail.

Electrostatic Charge Image Developing Toner

An electrostatic charge image developing toner according to an exemplary embodiment (hereinafter, referred to as “toner”) includes a toner particle that contains at least a binder resin including an amorphous polyester resin and a crystalline polyester resin and has a Young's modulus at 20° C. (hereinafter, sometimes referred to as a “Young's modulus (20° C.)”) of 3.0 GPa to 3.5 GPa.

When the toner according to the exemplary embodiment has the above-described configuration, while low temperature fixability is attained, image deletion is prevented. Although the reason is not clear, it may be assumed as follows.

As the binder resin in the toner particle, for example, a method for attaining low temperature fixability at the time of image formation by containing an amorphous polyester resin and a crystalline polyester resin in the binder resin is adopted. In order to impart the low temperature fixability to the toner, the crystalline polyester resin is contained therein, and thus the mechanical strength of the toner exhibiting low temperature fixability tends to be decreased. Therefore, in a developing unit of an image forming apparatus, when an external force of stirring or the like is applied to the toner exhibiting low temperature fixability, the toner particles are easily deformed and aggregates of the toner particles are easily formed. If the toner includes the aggregates of the toner particles, for example, at the time when a toner image is formed on a surface of a photoreceptor (image holding member), the aggregates of the toner particles easily remain on the surface of the photoreceptor. As a result, it is considered that image deletion easily occurs in the obtained image.

On the other hand, when the Young's modulus (20° C.) of the toner exhibiting low temperature fixability by the above-described configuration is within the above specific range, it is considered that the mechanical strength is increased and thus the toner is not easily deformed and the aggregates of the toner particles are not easily formed. Accordingly, it is considered that image deletion is prevented in the obtained image.

As the content of the crystalline polyester resin in the entire binder resin is increased, the mechanical strength of the toner is decreased. However, since the mechanical strength of the toner according to the exemplary embodiment is increased, it is considered that the aggregates of the toner particles are not easily formed even when the content of the crystalline polyester resin is increased. Accordingly, it is considered that image deletion is prevented in the obtained image.

In addition, when a toner having a small particle size (toner having a reduced particle size) is used, the toner is easily affected by an external force of stirring or the like and the aggregates of the toner particles are more easily formed due to an increase in the specific surface area of the toner particles. However, since the mechanical strength of the toner according to the exemplary embodiment is increased, it is considered that the aggregates of the toner particles are not easily formed even when the toner having a reduced particle size is used. Accordingly, it is considered that image deletion is prevented in the obtained image.

The phenomenon that the image deletion caused by the aggregates of the toner particles occurs is more easily observed in a case in which an image having a low image density (hereinafter, referred to as a “halftone image”) is formed. However, since the mechanical strength of the toner according to the exemplary embodiment is increased, it is considered that the aggregates of the toner particles are not easily formed. Accordingly, even in a halftone image, it is considered that image deletion is prevented in the obtained image.

Hereinafter, a toner according to the exemplary embodiment will be described in detail.

The toner according to the exemplary embodiment includes toner particles and as necessary, an external additive.

Toner Particles

The toner particles contain, for example, a binder resin including an amorphous polyester resin and a crystalline polyester resin, and as necessary, a colorant, a release agent, and other additives. Further, the toner particles may contain resin particles other than the binder resin and elastomer particles.

The Young's modulus (20° C.) of the toner particles according to the exemplary embodiment is from 3.0 GPa to 3.5 GPa as described above. When the Young's modulus (20° C.) is within the above range, while low temperature fixability is attained, image deletion is prevented. The range of the Young's modulus (20° C.) is preferably from 3.2 GPa to 3.5 GPa, and particularly preferably from 3.2 GPa to 3.4 GPa.

The Vickers hardness of the toner particles at 20° C. (hereinafter, sometimes referred to as “Vickers hardness (20° C.)”) is preferably from 0.1 GPa to 0.2 GPa. When the Young's modulus (20° C.) is within the above range and the Vickers hardness (20° C.) is also within this range, while low temperature fixability is attained, image deletion is more easily prevented.

Control of Young's Modulus (20° C.)

The Young's modulus (20° C.) may be controlled by selecting each polyester resin monomer of the amorphous polyester resin and the crystalline polyester resin included in the binder resin or adjusting properties such as a glass transition temperature. In addition, the Young's modulus (20° C.) may be also controlled by adjusting the content ratio of the amorphous polyester resin and the crystalline polyester resin. Furthermore, the Young's modulus may be controlled by containing resin particles other than the binder resin, and elastomer particles, described later, and adjusting the contents thereof. The Young's modulus may be also controlled by combining these conditions.

Control of Vickers Hardness (20° C.)

The Vickers hardness (20° C.) may be controlled by the same method as in the above-described control of the Young's modulus (20° C.)

The Young's modulus (20° C.) and the Vickers hardness (20° C.) are measured as follows.

First, the toner is collected from the developer, dispersed in ion exchange water, subjected to irradiation with ultrasonic waves to separate the external additive and the toner particles, and then subjected to filtration and washing treatments, to obtain only the toner particles.

The obtained toner particles are subjected to a 60 kN load with a tableting machine having a diameter of 12 mm to obtain a tablet for measurement having a height of 8 mm and a diameter of 12 mm.

For the tablets for measurement, the Young's modulus and the Vickers hardness are measured using a NANOINDENTER (registered trademark, manufactured by MTS Systems Inc.).

The measurement is carried out at 10 points in the same tablets for measurement under the conditions of a maximum load (Pmax): 0.8 [mN], indenter used: diamond, a Berkovich type with triangular pyramid, and temperature: 20° C. Specifically, for the surface of the tablet for measurement, the measurement is carried out at 5 points at an interval of 1 mm and for the rear surface thereof, the measurement is carried out at 5 points in the same manner.

The Young's modulus is calculated by the following two equations from the measurement results.

First, a contact stiffness S which is a gradient of a load curve after the indentation of a penetrator is calculated from a load-displacement curve. Next, a stiffness modulus Er is calculated by Equation (1) and a Young's modulus Es is calculated by Equation (2).

S=2/√π×Er√A (1)

Er=[(1−vs²)/Es+(1−vi²)/Ei]⁻¹ (2)

(Ei represents a modulus of the penetrator, vi represents a Poisson's ratio of the penetrator, and vs represents a Poisson's ratio of a sample.)

In addition, the Vickers hardness is calculated by the following four equations.

First, a contact depth h_{c} is calculated by Equation (3).

h_{c}=h−hₛ (3)

Here, the entire indentation depth is set to h, and hₛ is calculated by the following Equation (4) from the contact stiffness (stiffness) which is a gradient of the load curve after the indentation of the penetrator and the shape of the penetrator.

hₛ=ε×P/S (4)

Subsequently, using a geometrical shape of the penetrator and the contact depth h_{c}, a contact projection area A between the penetrator and the sample is calculated by Equation (5).

A=24.56H_{c}²+f₀(h_{c}) (5)

(Here, f₀ (h_{c}) represents a correction term obtained from the curve of the penetrator.)

Finally, using the calculated contact projection area A, the hardness H is obtained by Equation (6).

H=P/A (6)

The “crystalline” resin refers to a resin not having a stepwise endothermic change but having a definite endothermic peak in the measurement using a differential scanning calorimeter (DSC), and specifically refers to a resin having a half-value width of an endothermic peak in the measurement at a temperature rise rate of 10 (° C./min) of 10° C. or lower.

On the other hand, the “amorphous” resin refers to a resin a half-value width of more than 10° C., having stepwise endothermic change, or having no definite endothermic peak.

Binder Resin

The binder resin contained in the toner particles of the toner according to the exemplary embodiment includes an amorphous polyester resin and a crystalline polyester resin. The content of the crystalline polyester resin to be used is preferably from 3% by weight to 30% by weight with respect to the total amount of the binder resin from the viewpoints of imparting low temperature fixability and preventing image deletion. The content is more preferably from 5% by weight to 30% by weight and particularly preferably from 5% by weight to 20% by weight.

Amorphous Polyester Resin

Examples of the amorphous polyester resin include a condensation polymer of a polyvalent carboxylic acid and a polyol. A commercially available product or a synthesized product may be used as the amorphous polyester resin.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexane dicarboxylic acid), aromatic dicarboxylic acids (for example, terephthalic acid, isophthalic acid, phthalic acid, and naphthalene dicarboxylic acid), anhydrides thereof, or lower alkyl esters (having, for example, 1 to 5 carbon atoms) thereof. Among these, for example, aromatic dicarboxylic acids are preferable as the polyvalent carboxylic acid.

As the polyvalent carboxylic acid, a tri- or higher-valent carboxylic acid having a crosslinked structure or a branched structure may be used in combination together with a dicarboxylic acid. Examples of the tri- or higher-valent carboxylic acid include trimellitic acid, pyromellitic acid, anhydrides thereof, or lower alkyl esters (having, for example, 1 to 5 carbon atoms) thereof.

The polyvalent carboxylic acids may be used singly or in combination of two or more kinds thereof.

Examples of the polyol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adduct of bisphenol A and propylene oxide adduct of bisphenol A). Among these, for example, aromatic diols and alicyclic diols are preferable, and aromatic diols are more preferable as the polyol.

As the polyol, a tri- or higher-valent polyol having a crosslinked structure or a branched structure may be used in combination together with diol. Examples of the tri- or higher-valent polyol include glycerin, trimethylolpropane, and pentaerythritol.

The polyols may be used singly or in combination of two or more kinds thereof.

From the viewpoint of controlling the Young's modulus (20° C.) to the above specific range, an amorphous polyester resin containing aliphatic dicarboxylic acids, aromatic dicarboxylic acids, and tri- or higher-valent carboxylic acid as the polyvalent carboxylic acid, and aromatic diols as the polyol is preferably used.

The glass transition temperature (Tg) of the amorphous polyester resin is preferably from 50° C. to 80° C., and more preferably from 50° C. to 65° C.

The glass transition temperature is obtained from a DSC curve obtained by differential scanning calorimetry (DSC). More specifically, the glass transition temperature is obtained from “extrapolated glass transition onset temperature” described in the method of obtaining a glass transition temperature in JIS K-1987 “testing methods for transition temperatures of plastics”.

The weight average molecular weight (Mw) of the amorphous polyester resin is preferably from 5,000 to 1,000,000, and more preferably from 7,000 to 500,000.

The number average molecular weight (Mn) of the amorphous polyester resin is preferably from 2,000 to 100,000.

The molecular weight distribution Mw/Mn of the amorphous polyester resin is preferably from 1.5 to 100, and more preferably from 2 to 60.

The weight average molecular weight and the number average molecular weight are measured by gel permeation chromatography (GPC). The molecular weight measurement by GPC is performed using HLC-8120 GPC which is GPC manufactured by Tosoh Corporation as a measuring device, TSKGEL SUPER HM-M (15 cm) which is a column manufactured by Tosoh Corporation, and a THF solvent. The weight average molecular weight and the number average molecular weight are calculated using a molecular weight calibration curve plotted from a monodisperse polystyrene standard sample from the results of the above measurement.

A known production method is used to produce the amorphous polyester resin. Specific examples thereof include a method of conducting a reaction at a polymerization temperature set to from 180° C. to 230° C., as necessary, under reduced pressure in the reaction system, while removing water or an alcohol that is generated during condensation.

When monomers of the raw materials are not dissolved or compatibilized under a reaction temperature, a solvent having a high boiling point may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with the main component.

Crystalline Polyester Resin

Examples of the crystalline polyester resin include polycondensates of polyvalent carboxylic acids and polyols. A commercially available product or a synthesized product may be used as the crystalline polyester resin.

Here, as the crystalline polyester resin, a polycondensate using a polymerizable monomer having a linear aliphatic group is preferably used rather than a polymerizable monomer having an aromatic group, in order to easily form a crystal structure.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, or lower alkyl esters (having, for example, 1 to 5 carbon atoms) thereof.

As the polyvalent carboxylic acid, a tri- or higher-valent carboxylic acid having a crosslinked structure or a branched structure may be used in combination together with a dicarboxylic acid. Examples of the trivalent carboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, or lower alkyl esters (having, for example, 1 to 5 carbon atoms) thereof.

As the polyvalent carboxylic acid, a dicarboxylic acid having a sulfonic acid group or a dicarboxylic acid having an ethylenic double bond may be used in combination together with these dicarboxylic acids.

The polyvalent carboxylic acids may be used singly or in combination of two or more kinds thereof.

Examples of the polyol include aliphatic diols (for example, linear aliphatic diols having 7 to 20 carbon atoms in amain chain part). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol.

As the polyol, a tri- or higher-valent polyol having a crosslinked structure or a branched structure may be used in combination together with diol. Examples of the tri- or higher-valent polyol include glycerin, trimethylolethane, trimethylolpropane, and pentaerythritol.

The polyols may be used singly or in combination of two or more kinds thereof.

Here, in the polyol, the content of the aliphatic diol may be 80 mol % or more, and is preferably 90 mol % or more.

From the viewpoint of controlling the Young's modulus (20° C.) to the above specific range, a crystalline polyester resin using a polyvalent carboxylic acid containing an aliphatic polyvalent carboxylic acid having 6 to 20 carbon atoms including carbon of a carboxy group, and a polyol containing an aliphatic diol having 4 to 18 carbon atoms is preferably used. In addition, from the same viewpoint, the content of the aliphatic polyvalent carboxylic acid having 6 to 20 carbon atoms including carbon of a carboxy group is more preferably 80 mol % or more with respect to the total amount of the polyvalent carboxylic acids and the content of the aliphatic diols having 4 to 18 carbon atoms is more preferably 80 mol % or more with respect to the total amount of the polyols.

The melting temperature of the crystalline polyester resin is preferably from 50° C. to 100° C., more preferably from 55° C. to 90° C., and still more preferably from 60° C. to 85° C.

The melting temperature is obtained from “melting peak temperature” described in the method of obtaining a melting temperature in JIS K7121-1987 “testing methods for transition temperatures of plastics”, from a DSC curve obtained by differential scanning calorimetry (DSC).

The weight average molecular weight (Mw) of the crystalline polyester resin is preferably from 6,000 to 35,000.

For example, a known production method is used to produce the crystalline polyester resin as in the case of the amorphous polyester resin.

The content of the binder resin is, for example, preferably from 40% by weight to 95% by weight, more preferably from 50% by weight to 90% by weight, and even more preferably from 60% by weight to 85% by weight with respect to the total amount of the toner particles.

Further, a weight ratio of the amorphous polyester resin and the crystalline polyester resin in the binder resin is preferably from 1:19 to 1:4.

Resin Particles Other than Binder Resin

From the viewpoint of controlling the Young's modulus (20° C.) to the above specific range, resin particles other than the binder resin may be contained in the toner particles of the toner according to the exemplary embodiment.

When resin particles other than the binder resin are used, the content of the resin particles is preferably from 0% by weight to 25% by weight with respect to the total amount of the toner particles (however, excluding a release agent and a colorant) from viewpoint of preventing image deletion while attaining low temperature fixability. The content is more preferably from 2% by weight to 20% by weight, and still more preferably from 5% by weight to 15% by weight.

Resins included in the resin particles are not particularly limited and examples thereof include vinyl resins such as a styrene-(meth)acrylic resin; and polyester resins having an ethylenic double bond. In addition, the resins included in the resin particles may be used singly or in combination of two or more kinds thereof. Among these, as the resins included in the resin particles, vinyl resins are preferably used from the viewpoint of preventing image deletion while attaining low temperature fixability. A styrene-(meth)acrylic resin obtained by copolymerizing monomers of styrenes and monomers of (meth)acrylic acids is particularly preferably used. Hereinafter, the resins used for resin particles other than the binder resin will be described.

Examples of the vinyl reins include styrenes having a styrene moiety such as styrene, alkyl-substituted styrene (for example, α-methylstyrene, 2-methylstyere, 3-methylstyere, 4-methylstyere, 2-ethylstyrene, 3-ethylstyrene, and 4-ethylstyrene), halogen-substituted styrene (for example, 2-chlorostyrene, 3-chlorostyrene, and 4-chlorostyrene), and vinylnaphthalene; esters having a vinyl group such as methyl (meth)acrylate, ethyl (meth)acrylate, n-propyl (meth)acrylate, n-butyl (meth)acrylate, lauryl (meth)acrylate, and 2-ethylhexyl (meth)acrylate, trimethylolpropane trimethacrylate (TMPTMA); vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; and polymers of monomers such as (meth)acrylic acid, maleic acid, cinnamic acid, fumaric acid, and vinylsulfonic acid, which become materials for acids having a vinyl group and bases having a vinyl group such as ethyleneimine, vinylpyridine, and vinylamine.

As other monomers, monofunctional monomers such as vinyl acetate; bifunctional monomers such as ethylene glycol dimethacrylate, nonane diacrylate, and decanediol diacrylate; and polyfunctional monomers such as trimethylolpropane triacrylate and trimethylolpropane trimethacrylate may be used in combination thereof.

In addition, the vinyl resin may be a resin obtained by using these monomers singly or a resin of a copolymer obtained by using these monomers in combination of two or more kinds thereof.

Among these, as the vinyl resin, a copolymer including styrenes, esters having a vinyl group and acids having a vinyl group as monomers are preferable.

The expression “(meth)acryl” means both “acryl” and “meth acryl”.

The styrenes may be used singly or in combination of two or more kinds thereof.

Among these, as the styrenes, styrene is particularly preferably used from the viewpoints of ease in reaction, ease in reaction control, and ease in availability.

Among the esters having a vinyl group and acids having a vinyl group, monomers having a (meth)acrylic group (hereinafter, referred to as “(meth)acrylic acids”) are preferably used. Examples of (meth)acrylic acids include (meth)acrylic acid and (meth)acrylic ester. Examples of (meth)acrylic ester other than the aforementioned monomers include (meth)acrylic acid alkyl ester (n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, cyclohexyl (meth)acrylate, t-butylcyclohexyl (meth)acrylate and the like), (meth)acrylic acid aryl ester (phenyl (meth)acrylate, biphenyl (meth)acrylate, diphenylethyl (meth)acrylate, t-butylphenyl (meth)acrylate, terphenyl (meth)acrylate and the like), dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, and (meth)acrylamide.

The (meth)acrylic acids may be used singly or in combination of two or more kinds thereof.

Here, the weight ratio of the styrenes and the (meth)acrylic acids (styrenes/(meth)acrylic acids) is, preferably for example, from 85/15 to 70/30.

The polyester resin having an ethylenic double bond refers to a polycondensate formed by a polycondensation reaction of polyvalent carboxylic acids having an ethylenically unsaturated bond and polyols.

Specific examples of the polyvalent carboxylic acids having an ethylenically unsaturated bond include maleic acid, fumaric acid, maleic anhydride, itaconic acid, and itaconic anhydride.

In addition, specific example of the polyols include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adduct of bisphenol A and propylene oxide adduct of bisphenol A).

The weight average molecular weight (Mw) of the resin used for forming the resin particles other than the binder resin is, for example, from 5,000 to 500,000.

As the producing method of resin particles other than the binder resin, for example, known methods such as an emulsion polymerization method, a molten kneading method using a Banbury mixer, a kneader, or the like, a suspension polymerization method, and a spray drying method are used. Further, for example, a seed emulsion polymerization method in which monomers are added dropwise to a dispersion of resin particles or a dispersion of aggregates of resin particles is also used.

Elastomer Particles

From the viewpoint of controlling the Young's modulus (20° C.) to the above specific range, elastomer particles may be contained in the toner particles of the toner according to the exemplary embodiment.

When the elastomer particles are used, the content of the elastomer particles is preferably from 0% by weight to 25% by weight with respect to the total amount of the toner particles (however, excluding a release agent and a colorant) from the viewpoint of preventing image deletion while attaining low temperature fixability. The content is more preferably from 2% by weight to 20% by weight and still more preferably from 5% by weight to 15% by weight.

Examples of elastomers used for forming the elastomer particles include synthetic rubber such as urethane rubber, silicone rubber, fluorine rubber, chloroprene rubber, butadiene rubber, ethylene-propylene-diene copolymer rubber (EPDM), and epichlorohydrin rubber, polyolefin rubber, and polyvinyl chloride rubber.

Among these, from the viewpoint of easily forming the elastomer particles, as the elastomers used for forming the elastomer particles, elastomers having styrene as a constitutional unit are preferable.

Examples of the elastomers having styrene as a constitutional unit include a styrene-butadiene elastomer, a styrene-butadiene-styrene elastomer, a styrene-(butadiene/butylene)-styrene elastomer, a polystyrene-polyethylene/butylene-polystyrene elastomer, a styrene-isoprene-styrene elastomer, a styrene-hydrogenated polybutadiene-styrene elastomer, a styrene-hydrogenated polyisoprene-styrene elastomer, and a styrene-hydrogenated poly(isoprene/butadiene)-polystyrene elastomer.

The weight average molecular weight (Mw) of the elastomer is, for example, preferably from 30,000 to 300,000.

A producing method of the elastomer particles is not particularly limited and a known method is used. Examples thereof include a method of processing the elastomers into particles and a method of producing the elastomer particles by emulsion polymerization of the elastomers.

The toner particles in the exemplary embodiment contains the binder resin including the amorphous polyester resin and the crystalline polyester resin and the Young's modulus (20° C.) is from 3.0 GPa to 3.5 GPa as described above.

Here, a more preferable example of a component forming the toner particles exhibiting a Young's modulus (20° C.) of 3.0 GPa to 3.5 GPa will be described.

The binder resin preferably includes an amorphous polyester resin containing polyvalent carboxylic acids including an aliphatic dicarboxylic acid (for example, alkenyl succinic acid), an aromatic dicarboxylic acid (for example, terephthalic acid), and a tri- or higher-valent carboxylic acid (for example, aromatic tricarboxylic acid), and a polyol such as an aromatic diol (for example, alkylene oxide adduct of bisphenol A (for example, 2 to 4 carbon atoms)), as monomer components, and a crystalline polyester resin including a polyvalent carboxylic acid containing 80 mol % or more of an aliphatic polycarboxylic acid having 6 to 20 carbon atoms including carbon of a carboxy group, and a polyol containing 80 mol % or more of an aliphatic diol having 4 to 18 carbon atoms, as monomer components. At this time, the content of the crystalline polyester resin is preferably from 5% by weight to 20% by weight with respect to the total amount of the binder resin.

Further, when the toner includes resin particles other than the binder resin (for example, styrene-(meth)acrylic resin particles), the content of the resin particles is preferably from 0% by weight to 25% by weight with respect to the total amount of the toner particles (however, excluding a release agent and a colorant).

When the toner includes elastomer particles, the content of the elastomer particles is preferably, for example, from 0% by weight to 25% by weight with respect to the total amount of the toner particles (however, excluding a release agent and a colorant).

Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, Rhodamine B Lake, Lake Red C, pigment red, rose bengal, aniline blue, ultramarine blue, calco oil blue, methylene blue chloride, phthalocyanine blue, pigment blue, phthalocyanine green, and malachite green oxalate, and various dyes such as acridine dyes, xanthene dyes, azo dyes, benzoquinone dyes, azine dyes, anthraquinone dyes, thioindigo dyes, dioxadine dyes, thiazine dyes, azomethine dyes, indigo dyes, phthalocyanine dyes, aniline black dyes, polymethine dyes, triphenylmethane dyes, diphenylmethane dyes, and thiazole dyes.

The colorants may be used singly or in combination of two or more kinds thereof.

As necessary, the colorant may be surface-treated or used in combination with a dispersant. Plural kinds of colorants may be used in combination.

The content of the colorant is, for example, preferably from 1% by weight to 30% by weight, and more preferably from 3% by weight to 15% by weight with respect to the total amount of the toner particles.

Release Agent

Examples of the release agent include hydrocarbon wax; natural wax such as carnauba wax, rice wax and candelilla wax; synthetic or mineral and petroleum wax such as montan wax; and ester wax such as fatty acid ester and montanic acid ester. However, the release agent is not limited thereto.

The melting temperature of the release agent is preferably from 50° C. to 110° C. and more preferably from 60° C. to 100° C.

In addition, the melting temperature is calculated from the DSC curve obtained from differential scanning calorimetry (DSC) according to a “melting peak temperature” described in a method of calculating melting temperature in “Testing methods for transition temperatures of plastics” of JIS K-1987.

The content of the release agent is preferably, for example, from 1% by weight to 20% by weight and more preferably from 5% by weight to 15% by weight with respect to the total amount of the toner particles.

Other Additives

Examples of the other additives include known additives such as a magnetic material, a charge-controlling agent, and an inorganic powder. These additives are contained in the toner particles as an internal additive.

Properties of Toner Particles and the Like

The toner particles may be toner particles having a single layer structure, or may be toner particles having a so-called core-shell structure constituted by a core (core particle) and a coating layer (shell layer) coating the core.

Here, the toner particles having a core-shell structure may be preferably constituted by the core containing a binder resin, and, as necessary, other additives such as a colorant and a release agent, and the coating layer containing a binder resin.

The volume average particle size (D50v) of the toner particles is preferably from 2 μm to 10 μm, and more preferably from 4 μm to 8 μm.

Various kinds of average particle sizes and particle size distribution indexes of the toner particles are measured using a COULTER MULTISIZER II (manufactured by Beckman Coulter, Inc.). ISOTON-II (manufactured by Beckman Coulter, Inc.) is used as an electrolyte.

In the measurement, 0.5 mg to 50 mg of a measurement sample is added to 2 ml of a 5% aqueous solution of a surfactant (sodium alkyl benzene sulfonate is preferable) as a dispersant. The mixture is added to 100 ml to 150 ml of the electrolyte.

The electrolyte in which the sample is suspended is subjected to a dispersion treatment for 1 minute by an ultrasonic dispersing machine, and the COULTER MULTISIZER II measures a particle size distribution of particles of from 2 μm to 60 μm by using an aperture having an aperture diameter of 100 μm. 50,000 particles are sampled.

A cumulative distribution is drawn from the smallest diameter side for the volume and the number with respect to particle size ranges (channels) divided based on the particle size distributions measured in this manner. The particle sizes corresponding to 16% in the cumulative distributions are defined as a volume particle size D16v and a number particle size D16p, the particle sizes corresponding to 50% in the cumulative distributions are defined as a volume average particle size D50v and a cumulative number average particle size D50p, and the particle sizes corresponding to 84% in the cumulative distributions are defined as a volume particle size D84v and a number particle size D84p.

Using these particle sizes, a volume average particle size distribution index (GSDv) is calculated as (D84v/D16v)^{1/2} and a number average particle size distribution index (GSDp) is calculated as (D84p/D16p)^{1/2}.

The shape factor SF1 of the toner particle is preferably from 110 to 150 and more preferably from 120 to 140.

Here, the shape factor SF1 is obtained by the following Equation.

Equation: SF1=(ML²/A)×(π/4)×100

In the equation, ML represents an absolute maximum length of the toner particle, and A represents a projected area of the toner particle.

Specifically, the shape factor SF1 is calculated as follows mainly using a microscopic image or an image of a scanning electron microscope (SEM) that is analyzed using an image analyzer to be digitalized. That is, an optical microscopic image of particles sprayed on the surface of a glass slide is scanned into an image analyzer LUZEX (manufactured by Nireco Corporation) through a video camera, the maximum lengths and the projected areas of 100 particles are obtained for calculation using the above-described equation, and an average value thereof is obtained.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄ and MgSO₄.

The surfaces of the inorganic particles as the external additive may be subjected to a hydrophobization treatment. For example, the hydrophobization treatment is performed, by immersing the inorganic particles in a hydrophobizing agent. The hydrophobizing agent is not particularly limited and examples thereof include a silane coupling agent, silicone oil, a titanate coupling agent and an aluminum coupling agent. These may be used singly or in combination of two or more kinds.

For example, the amount of the hydrophobizing agent is typically from 1 part by weight to 10 parts by weight with respect to 100 parts by weight of the inorganic particles.

Examples of the external additives also include resin particles (resin particles such as polystyrene, polymethyl methacrylate (PMMA) and melamine resin) and cleaning aids (for example, a metal salt of higher fatty acid represented by zinc stearate and a particle of a fluorine polymer).

The amount of the external additive externally added is, for example, preferably from 0.01% by weight to 5% by weight and more preferably from 0.01% by weight to 2.0% by weight with respect to the total amount of the toner particles.

Preparing Method of Toner

Hereinafter, a preparing method of a toner according to the exemplary embodiment will be described.

The toner according to the exemplary embodiment is obtained by externally adding an external additive to toner particles after the toner particles are prepared.

The toner particles may be prepared, by any of a dry method (for example, kneading and pulverizing method) and a wet method (for example, an aggregation and coalescence method, a suspension polymerization method and a dissolution suspension method). The preparing method of the toner particles is not limited thereto and a known method may be employed.

Among these methods, the aggregation and coalescence method may be preferably employed to obtain the toner particles.

Specifically, for example, when the toner particles are prepared using the aggregation and coalescence method, the toner particles are prepared through a process of preparing a binder resin particle dispersion in which binder resin particles which become a binder resin are dispersed (binder resin particle dispersion preparing process), a process of forming aggregated particles by aggregating the binder resin particles (as necessary, other particles) in the binder resin particle dispersion (as necessary, in the dispersion after other particle dispersions are mixed) (aggregated particle forming process), and a process of forming toner particles by heating an aggregated particle dispersion in which the aggregated particles are dispersed to coalesce the aggregated particles (coalescence process).

In addition, for example, when the toner particles according to the exemplary embodiment are prepared, in a case of using resin particles other than the binder resin (for example, a styrene-(meth)acrylic resin) and elastomer particles, in addition to a process of preparing an amorphous polyester resin particle dispersion which becomes a binder resin and a crystalline polyester resin particle dispersion, a process of preparing a dispersion of resin particles other than the binder resin (for example, styrene-acryl) and an elastomer particle diseprsion (for example, a styrene-butadiene copolymer) is further added.

Hereinafter, each process will be described in detail.

While a method of obtaining toner particles containing a colorant and a release agent will be described in the following description, the colorant and the release agent are used as necessary. Any additive other than colorants and release agents may of course be used.

Binder Resin Particle Dispersion Preparing Process

First, along with a resin particle dispersion in which binder resin particles which become a binder resin are dispersed, for example, a colorant particle dispersion in which colorant particles are dispersed, and a release agent dispersion in which release agent particles are dispersed are prepared. Further, when resin particles other than the binder resin (for example, a styrene-(meth)acrylic resin) and elastomer particles (for example, a styrne-butadien elastomer) are used, a dispersion of resin particles other than the binder resin and an elastomer particle dispersion are prepared.

Here, the binder resin particle dispersion is prepared, for example, by dispersing the binder resin particles in a dispersion medium by aid of a surfactant.

An example of the dispersion medium used in the binder resin particle dispersion includes an aqueous medium.

Examples of the aqueous medium include water such as distilled water and ion exchange water, and alcohols and the like. These may be used singly or in combination of two or more kinds thereof.

Examples of the surfactant include anionic surfactants such as sulfuric ester salts, sulfonates, phosphoric esters and soap surfactants; cationic surfactants such as amine salts and quaternary ammonium salts; and nonionic surfactants such as polyethylene glycol, alkylphenol ethylene oxide adducts and polyols. Among these, particularly, anionic surfactants and cationic surfactants are preferable. The nonionic surfactants may be used in combination with anionic surfactants or cationic surfactants.

The surfactants may be used singly or in combination of two or more kinds thereof.

In the binder resin particle dispersions, the binder resin particles may be dispersed in the dispersion medium by a general dispersion method, for example, by using a rotary shear type homogenizer, or a ball mill, a sand mill or a DYNO MILL having media. Further, depending on the kind of binder resin particles, the resin particles may be dispersed in the resin particle dispersion, for example, by phase inversion emulsification.

The phase inversion emulsification is a method in which a resin to be dispersed is dissolved in a hydrophobic organic solvent capable of dissolving the resin, a base is added to the organic continuous phase (O phase) to neutralize the resin, an aqueous medium (W phase) is added to invert the resin into a discontinuous phase, from W/O to O/W (so-called phase inversion), so that the resin may be dispersed in the form of particles in the aqueous medium.

The volume average particle size of the resin particles dispersed in the binder resin particle dispersions is preferably, for example, from 0.01 μm to 1 μm, more preferably from 0.08 μm to 0.8 μm, and still more preferably from 0.1 μm to 0.6 μm.

In addition, the volume average particle size of the binder resin particles is measured such that using the particle size distribution measured by a laser diffraction particle size distribution analyzer (for example, LA-700, manufactured by Horiba Seisakusho Co., Ltd.), a cumulative distribution is drawn from the small diameter side with respect to the volume based on the divided particle size ranges (channels) and the particle size at which the cumulative volume distribution reaches 50% of the total particles is defined as a volume average particle size D50v. Hereinafter, the volume average particle size of particles in the other dispersion is measured in the same manner.

For example, the content of the binder resin particles contained in the binder resin particle dispersion is preferably from 5% by weight to 50% by weight and more preferably from 10% by weight to 40% by weight.

For example, when the colorant particle dispersion, the release agent particle dispersion, and the resin particles other than the binder resin and the elastomer particles are used in a manner similar to the binder resin particle dispersion, a dispersion of the resin particles other than the binder resin and an elastomer particle dispersion are also prepared. That is, with respect to the volume average particle size of the particles, the dispersion medium, the dispersion method and the content of the particles in the binder resin particle dispersion, the same is applied to the colorant particles dispersed in the colorant particle dispersion and the release agent particles dispersed in the release agent dispersion, and further, the dispersion of the resin particles other than the binder resin and the elastomer particle dispersion.

Aggregated Particle Forming Process

Next, along with the binder resin particle dispersion, the colorant particle dispersion and the release agent particle dispersion are mixed. Further, when the resin particles other than the binder resin and the elastomer particles are used, the dispersion of the resin particles other than the binder resin and the elastomer particle dispersion are mixed.

Then, in the mixed dispersion, the binder resin particles, the colorant particles and the release agent particles are heteroaggregated to form aggregated particles containing the binder resin particles, the colorant particles and the release agent particles, which approximately have the targeted particle size of the toner particle. When the resin particles other than the binder resin and the elastomer particles are used, aggregated particles containing the resin particles other than the binder resin and the elastomer particles are formed.

Specifically, for example, an aggregation agent is added to the mixed dispersion, and the pH of the mixed dispersion is adjusted to an acidic range (for example, from pH 2 to pH 5). As necessary, a dispersion stabilizer is added thereto, followed by heating to the glass transition temperature of the binder resin particles (specifically, from the temperature 30° C. lower than the glass transition temperature of the binder resin particles to the temperature 10° C. lower than the glass transition temperature). The particles dispersed in the mixed dispersion are aggregated to form aggregated particles.

In the aggregated particle forming process, for example, the aggregation agent is added to the mixed dispersion while stirring using a rotary shear type homogenizer at room temperature (for example, 25° C.), and the pH of the mixed dispersion is adjusted to an acidic range (for example, from pH 2 to pH 5). As necessary, a dispersion stabilizer may be added thereto, followed by heating.

Examples of the aggregation agent include a surfactant having a polarity opposite to the polarity of the surfactant used as the dispersant which is added to the mixed dispersion, an inorganic metal salt and a divalent or higher-valent metal complex. In particular, when a metal complex is used as an aggregation agent, the amount of the surfactant used is reduced, which results in improvement of charging properties.

An additive capable of forming a complex or a similar bond with a metal ion in the aggregation agent may be used as necessary. As the additive, a chelating agent is suitably used.

Examples of the inorganic metal salt include metal salts such as calcium chloride, calcium nitrate, barium chloride, magnesium chloride, zinc chloride, aluminum chloride and aluminum sulfate, and polymers of inorganic metal salts such as polyaluminum chloride, polyaluminum hydroxide and calcium polysulfide.

The chelating agent may be a water soluble chelating agent. Examples of the chelating agent include oxycarboxylic acids such as tartaric acid, citric acid and gluconic acid, iminodiacetic acid (IDA), nitrilotriacetic acid (NTA), and ethylenediaminetetraacetic acid (EDTA).

The amount of the chelating agent added is preferably from 0.01 part by weight to 5.0 parts by weight and more preferably 0.1 part by weight or more and less than 3.0 parts by weight with respect to 100 parts by weight of the resin particles.

Coalescence Process

Next, the aggregated particles are coalesced by heating the aggregated particle dispersion having the aggregated particles dispersed therein to, for example, the glass transition temperature of the binder resin particles (for example, a temperature 10° C. to 30° C. higher than the glass transition temperature of the binder resin particles) or higher, to form toner particles.

The toner particles are obtained by the above-described processes.

Further, the toner particles may be prepared by a process of forming second aggregated particles by obtaining an aggregated particle dispersion having the aggregated particles dispersed therein, mixing the aggregated particle dispersion and the binder resin particle dispersion having the binder resin particles dispersed therein, and further performing aggregation so as to attach the binder resin particles on the surface of the aggregated particles, and a process of coalescing the second aggregated particles by heating a second aggregated particle dispersion having the second aggregated particles dispersed therein to form toner particles having a core/shell structure.

Here, after the coalescence process is completed, the toner particles formed in the solution are subjected to washing, solid-liquid separation and drying processes as known in the related art to obtain dried toner particles.

Preferably, the washing process may be sufficiently performed by replacement washing with ion exchange water from the viewpoint of charging properties. The solid-liquid separation process is not particularly limited but may be performed by filtration under suction or pressure from the viewpoint of productivity. The drying process is not particularly limited but may be preferably performed by freeze-drying, flash jet drying, fluidized drying or vibration fluidized drying from the viewpoint of productivity.

The toner according to the exemplary embodiment is prepared, for example, by adding and mixing the external additive to the obtained dried toner particles. The mixing may preferably be performed by a V-blender, a HENSCHEL mixer, a LÖDIGE mixer and the like. Further, as necessary, coarse particles of the toner may be removed using a vibration sieve or a wind classifier.

Electrostatic Charge Image Developer

An electrostatic charge image developer according to the exemplary embodiment includes at least the toner according to the exemplary embodiment.

The electrostatic charge image developer according to the exemplary embodiment may be a single component developer including only the toner according to the exemplary embodiment and may be a two-component developer in which the toner and a carrier are mixed.

The carrier is not particularly limited and known carriers may be used. Examples of the carrier include a coated carrier in which the surface of a core formed with a magnetic particle is coated with a coating resin; a magnetic particle-dispersed carrier in which a magnetic particle is dispersed and blended in a matrix resin; and a resin impregnated carrier in which a porous magnetic particle is impregnated with a resin.

The magnetic particle dispersed carrier and resin impregnated carrier may be carriers each having the constitutional particle of the carrier as a core and a coating resin coating the core.

Examples of the magnetic particle include magnetic metal such as iron, nickel, or cobalt and a magnetic oxide such as ferrite and magnetite.

Examples of the conductive particles include metal particles of gold, silver and copper and the like, and particles of carbon black, titanium oxide, zinc oxide, tin oxide, barium sulfate, aluminum borate, potassium titanate or the like.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin containing an organosiloxane bond or a modified article thereof, a fluoro resin, polyester, polycarbonate, a phenol resin, and an epoxy resin.

The coating resin and the matrix resin may contain other additives such as conductive materials and the like.

Here, in order to coat the surface of the core with the coating resin, a coating method using a coating resin and a coating layer forming solution in which various kinds of additives are dissolved in an appropriate solvent, as necessary, may be used. The solvent is not particularly limited and may be selected depending on a coating resin to be used and application suitability.

Specific examples of the resin coating method include a dipping method including dipping a core in a coating layer forming solution, a spray method including spraying a coating layer forming solution to the surface of a core, a fluidized-bed method including spraying a coating layer forming solution to a core while the core is suspended by a fluidizing air, and a kneader coater method including mixing a core of a carrier with a coating layer forming solution in a kneader coater, and then removing the solvent.

In the two-component developer, a mixing ratio (weight ratio) of the toner and the carrier is preferably toner:carrier of 1:100 to 30:100, and more preferably 3:100 to 20:100.

Image Forming Apparatus and Image Forming Method

The image forming apparatus and the image forming method according to the exemplary embodiment will be described.

The image forming apparatus according to the exemplary embodiment includes an image holding member, a charging unit that charges a surface of the image holding member, an electrostatic charge image forming unit that forms an electrostatic charge image on a charged surface of the image holding member, a developing unit that accommodates an electrostatic charge image developer and develops the electrostatic charge image formed on the surface of the image holding member as a toner image with the electrostatic charge image developer, a transfer unit that transfers the toner image formed on the surface of the image holding member onto a surface of a recording medium, and a fixing unit that fixes the toner image transferred onto the surface of the recording medium. As the electrostatic charge image developer, the electrostatic charge image developer according to the exemplary embodiment is used.

In the image forming apparatus according to the exemplary embodiment, there is carried out an image forming method (an image forming method according to the exemplary embodiment) including a process of charging a surface of an image holding member, a process of forming an electrostatic charge image on a charged surface of the image holding member, a process of developing the electrostatic charge image formed on the surface of the image holding member as a toner image using the electrostatic charge image developer according to the exemplary embodiment, a process of transferring the toner image formed on the surface of the image holding member onto a surface of a recording medium, and a process of fixing the toner image transferred onto the surface of the recording medium.

As the image forming apparatus according to the exemplary embodiment, known image forming apparatuses such as a direct transfer type image forming apparatus which directly transfers a toner image formed on a surface of an image holding member onto a recording medium; an intermediate transfer type image forming apparatus which primarily transfers a toner image formed on a surface of an image holding member onto a surface of an intermediate transfer member and secondarily transfers the toner image transferred on the surface of the intermediate transfer member onto a surface of a recording medium; an image forming apparatus including a cleaning unit which cleans a surface of an image holding member after a toner image is transferred and before charging; and an image forming apparatus including an erasing unit which erases a surface of an image holding member and after a toner image is transferred and before charging by irradiating the surface with erasing light may be used.

In the case of the intermediate transfer type image forming apparatus, for example, a transfer unit includes an intermediate transfer member to the surface of which a toner image is transferred, a primary transfer unit which primarily transfers the toner image formed on the surface of the image holding member onto the surface of the intermediate transfer member, and a secondary transfer unit which secondarily transfers the toner image transferred onto the surface of the intermediate transfer member onto a surface of a recording medium.

In the image forming apparatus according to the exemplary embodiment, for example, a portion including the developing unit may have a cartridge structure (process cartridge) which is detachable from the image forming apparatus. As the process cartridge, for example, a process cartridge which is provided with the developing unit accommodating the electrostatic charge image developer according to the exemplary embodiment is suitably used.

Hereinafter, an example of the image forming apparatus according to the exemplary embodiment will be shown, but there is no limitation thereto. In addition, main parts shown in the drawing will be described, and the descriptions of the other parts will be omitted.

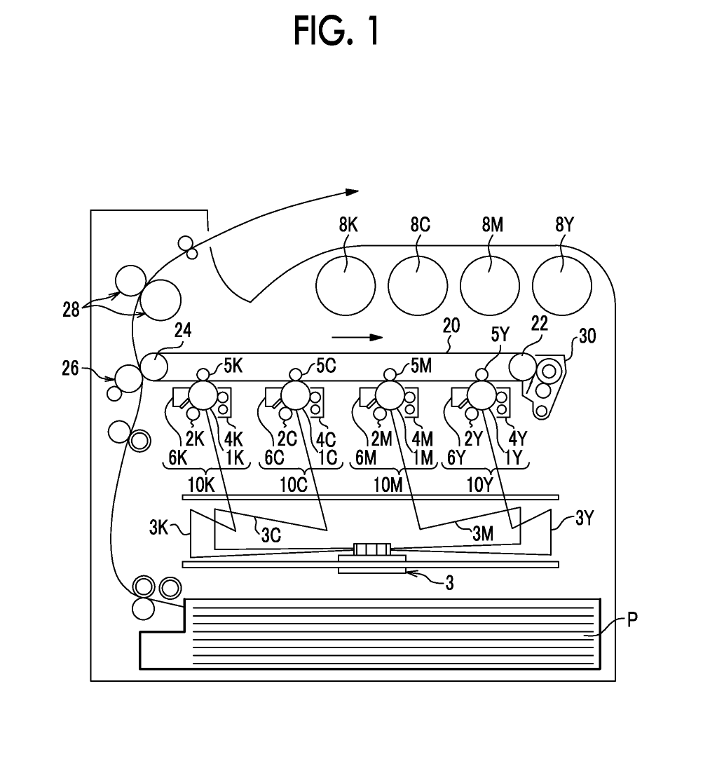

FIG. 1 is a schematic configuration diagram showing an image forming apparatus according to an exemplary embodiment.

The image forming apparatus shown in FIG. 1 includes first to fourth electrophotographic image forming units (image forming units) 10Y, 10M, 10C, and 10K which output images of the respective colors including yellow (Y), magenta (M), cyan (C), and black (K) based on color-separated image data. These image forming units (hereinafter, also referred to simply as “units” in some cases) 10Y, 10M, 10C and 10K are aligned in the horizontal direction with predetermined distances therebetween. Incidentally, each of these units 10Y, 10M, 10C and 10K may be a process cartridge which is detachable from the image forming apparatus.

An intermediate transfer belt 20 is provided through each unit as an intermediate transfer member extending above each of the units 10Y, 10M, 10C and 10K in the drawing. The intermediate transfer belt 20 is provided so as to be wound around a drive roller 22 and a support roller 24 contacting the inner surface of the intermediate transfer belt 20, which are separated from each other from left to right in the drawing. The intermediate transfer belt 20 travels in a direction from the first unit 10Y to the fourth unit 10K. Incidentally, the support roller 24 is pushed in a direction of separation from the drive roller 22 by a spring or the like (not shown), such that tension is applied to the intermediate transfer belt 20 which is wound around the support roller 24 and the drive roller 22. Also, on the surface of the image holding member side of the intermediate transfer belt 20, an intermediate transfer member cleaning device 30 is provided opposing the drive roller 22.

In addition, toners in the four colors of yellow, magenta, cyan and black, which are accommodated in toner cartridges 8Y, 8M, 8C and 8K, respectively, are supplied to developing devices (developing units) 4Y, 4M, 4C and 4K of the above-described units 10Y, 10M, 10C and 10K, respectively.

Since the first to fourth units 10Y, 10M, 10C, and 10K have the same configuration, the first unit 10Y, which is provided on the upstream side in the travelling direction of the intermediate transfer belt and forms a yellow image, will be described as a representative example. In addition, the same components as those of the first unit 10Y are represented by reference numerals to which the symbols M (magenta), C (cyan), and K (black) are attached instead of the symbol Y (yellow), and the descriptions of the second to fourth units 10M, 10C, and 10K, will be omitted.

The first unit 10Y includes a photoreceptor 1Y functioning as the image holding member. Around the photoreceptor 1Y, there are sequentially disposed a charging roller 2Y (an example of the charging unit) for charging the surface of the photoreceptor 1Y to a predetermined potential, an exposure device 3 (an example of the electrostatic charge image forming unit) for exposing the charged surface with a laser beam 3Y based on a color-separated image signal to form an electrostatic charge image, the developing device 4Y (an example of the developing unit) for supplying a charged toner into the electrostatic charge image to develop the electrostatic charge image, a primary transfer roller 5Y (an example of the primary transfer unit) for transferring the developed toner image onto the intermediate transfer belt 20, and a photoreceptor cleaning device 6Y (an example of the cleaning unit) for removing the toner remaining on the surface of the photoreceptor 1Y after the primary transfer.

The primary transfer roller 5Y is disposed inside the intermediate transfer belt 20 and provided in a position opposite to the photoreceptor 1Y. Further, bias power supplies (not shown), which apply primary transfer biases, are respectively connected to the respective primary transfer rollers 5Y, 5M, 5C and 5K. A controller (not shown) controls the respective bias power supplies to change the transfer biases which are applied to the respective primary transfer rollers.

Hereinafter, the operation of forming a yellow image in the first unit 10Y will be described.

First, before the operation, the surface of the photoreceptor 1Y is charged to a potential of −600 V to −800 V by the charging roller 2Y.

The photoreceptor 1Y is formed by stacking a photosensitive layer on a conductive substrate (volume resistivity at 20° C.: 1×10⁻⁶ Ωcm or lower). In general, this photosensitive layer has high resistance (resistance similar to that of general resin), and has properties in which, when irradiated with the laser beam 3Y, the specific resistance of a portion irradiated with the laser beam changes. Therefore, the laser beam 3Y is output to the charged surface of the photoreceptor 1Y through the exposure device 3 in accordance with yellow image data sent from the controller (not shown). The photosensitive layer on the surface of the photoreceptor 1Y is irradiated with the laser beam 3Y, and thus an electrostatic charge image having a yellow image pattern is formed on the surface of the photoreceptor 1Y.

The electrostatic charge image is an image which is formed on the surface of the photoreceptor 1Y by charging and is a so-called negative latent image which is formed when the specific resistance of a portion, which is irradiated with the laser beam 3Y, of the photosensitive layer is reduced and the charge flows on the surface of the photoreceptor 1Y and, in contrast, the charge remains in a portion which is not irradiated with the laser beam 3Y.

The electrostatic charge image formed on the photoreceptor 1Y is rotated to a predetermined development position along with the travel of the photoreceptor 1Y. At this development position, the electrostatic charge image on the photoreceptor 1Y is visualized (developed) as a toner image by the developing device 4Y.

The developing device 4Y accommodates, for example, the electrostatic charge image developer, which contains at least a yellow toner and a carrier. The yellow toner is frictionally charged by being stirred in the developing device 4Y to have a charge with the same polarity (negative polarity) as that of a charge on the photoreceptor 1Y and is maintained on a developer roller (as an example of the developer holding member). When the surface of the photoreceptor 1Y passes through the developing device 4Y, the yellow toner is electrostatically attached to a latent image portion which has been erased on the surface of the photoreceptor 1Y, and the latent image is developed with the yellow toner. The photoreceptor 1Y on which a yellow toner image is formed continuously travels at a predetermined rate, and the toner image developed on the photoreceptor 1Y is transported to a predetermined primary transfer position.

When the yellow toner image on the photoreceptor 1Y is transported to the primary transfer position, a primary transfer bias is applied to the primary transfer roller 5Y, an electrostatic force directed from the photoreceptor 1Y toward the primary transfer roller 5Y acts on the toner image, and the toner image on the photoreceptor 1Y is transferred onto the intermediate transfer belt 20. The transfer bias applied at this time has a (+) polarity opposite to the (−) polarity of the toner and for example, in the first unit 10Y, is controlled to +10 μA by the controller (not shown).

On the other hand, the toner remaining on the photoreceptor 1Y is removed and collected by the photoreceptor cleaning device 6Y.

In addition, primary transfer biases to be applied respectively to the primary transfer rollers 5M, 5C and 5K at the second unit 10M and subsequent units, are controlled similarly to the primary transfer bias of the first unit.

In this manner, the intermediate transfer belt 20 having a yellow toner image transferred thereonto in the first unit 10Y is sequentially transported through the second to fourth units 10M, 10C and 10K, and toner images of respective colors are superimposed and multi-transferred.

The intermediate transfer belt 20 having the four toner images multi-transferred thereonto through the first to fourth units arrives at a secondary transfer portion which is configured to have the intermediate transfer belt 20, the support roller 24 contacts with the inner surface of the intermediate transfer belt and a secondary transfer roller 26 (an example of the secondary transfer unit) disposed on the side of the image holding surface of the intermediate transfer belt 20. On the other hand, a recording sheet P (an example of the recording medium) is supplied to a gap at which the secondary transfer roller 26 and the intermediate transfer belt 20 are brought into contact with each other at a predetermined timing through a supply mechanism and a secondary transfer bias is applied to the support roller 24. The transfer bias applied at this time has the same (−) polarity as the (−) polarity of the toner, and an electrostatic force directing from the intermediate transfer belt 20 toward the recording sheet P acts upon the toner image, whereby the toner image on the intermediate transfer belt 20 is transferred onto the recording sheet P. Incidentally, at this time, the secondary transfer bias is determined depending upon a resistance detected by a resistance detecting unit (not shown) for detecting a resistance of the secondary transfer portion, and the voltage is controlled.

Then, the recording sheet P is sent to a press contact portion (nip portion) of a pair of fixing rollers in a fixing device 28 (an example of the fixing unit), and the toner image is fixed onto the recording sheet P to form a fixed image.

Examples of the recording sheet P onto which the toner image is transferred include plain paper used for electrophotographic copying machines, printers and the like. As the recording medium other than the recording sheet P, OHP sheets may be used.

In order to improve the smoothness of the image surface after the fixing, the surface of the recording sheet P is preferably smooth, and for example, coated paper in which the surface of plain paper is coated with a resin and the like, art paper for printing and the like are suitably used.

The recording sheet P in which fixing of a color image is completed is discharged to an ejection portion, and thus a series of the color image formation operations ends.

Process Cartridge and Toner Cartridge

A process cartridge according to the exemplary embodiment will be described.

The process cartridge according to the exemplary embodiment includes a developing unit, which accommodates the electrostatic charge image developer according to the exemplary embodiment and develops an electrostatic charge image formed on a surface of an image holding member as a toner image with the electrostatic charge image developer, and is detachable from the image forming apparatus.

The configuration of the process cartridge according to the exemplary embodiment is not limited thereto and may include a developing device and, additionally, at least one selected from other units such as an image holding member, a charging unit, an electrostatic charge image forming unit, and a transfer unit, as necessary.

Hereinafter, an example of the process cartridge according to the exemplary embodiment will be shown but the process cartridge is not limited thereto. Main parts shown in the drawing will be described and the descriptions of other parts will be omitted.

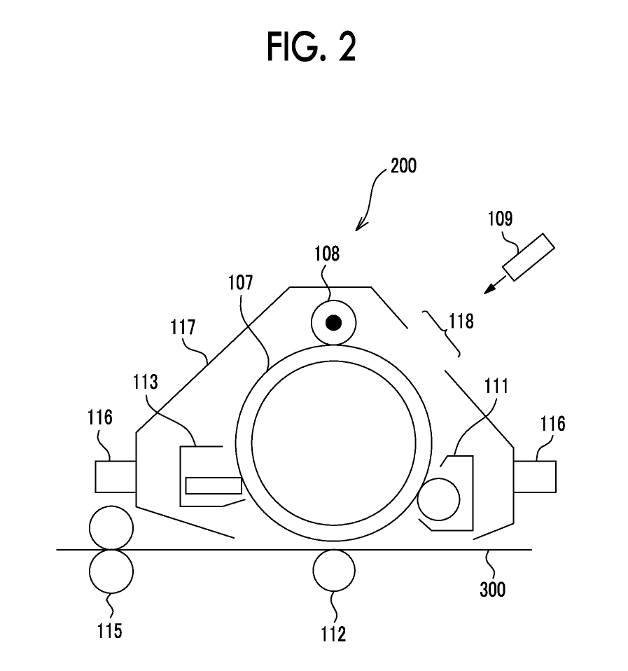

FIG. 2 is a schematic configuration diagram showing a process cartridge according to an exemplary embodiment.

A process cartridge 200 shown in FIG. 2 includes, a photoreceptor 107 (an example of the image holding member), and a charging roller 108 (an example of the charging unit), a developing device 111 (an example of the developing unit) and a photoreceptor cleaning device 113 (an example of the cleaning unit) provided around the photoreceptor 107, all of which are integrally combined and supported, for example, by a housing 117 provided with a mounting rail 116 and an opening portion 118 for exposure to form a cartridge.

In FIG. 2,109 denotes an exposure device (an example of the electrostatic charge image forming unit), 112 denotes a transfer device (an example of the transfer unit), 115 denotes a fixing device (an example of the fixing unit), and 300 denotes recording sheet (an example of the recording medium).

Next, a toner cartridge according to the exemplary embodiment will be described.

The toner cartridge according to the exemplary embodiment is a toner cartridge including a container which accommodates the toner according to the exemplary embodiment therein and is detachable from the image forming apparatus. The toner cartridge accommodates the toner for replenishment to be supplied to the developing unit provided in the image forming apparatus.

The image forming apparatus shown in FIG. 1 is an image forming apparatus having a configuration in which the toner cartridges 8Y, 8M, 8C, and 8K are detachable therefrom and the developing devices 4Y, 4M, 4C, and 4K are respectively connected to toner cartridges corresponding to each developing device (color) through a toner supply tube (not shown). Also, in the case where the toner accommodated in the toner cartridge runs low, the toner cartridge is replaced.

### EXAMPLES

The exemplary embodiments are more specifically described below with reference to Examples, but the exemplary embodiments are not limited to these Examples. In the following description, “parts” and “%” are based on weight unless otherwise indicated.

Preparation of Amorphous Polyester Resin Particle Dispersion

Preparation of Amorphous Polyester Resin Particle Dispersion (A1)

10 mol % of a bisphenol A ethylene oxide 2-mol adduct (BPA-EO) and 40 mol % of a bisphenol A propylene oxide 2-mol adduct (BPA-PO) as polyol components, and 40 mol % of terephthalic acid (TPA), 5 mol % of dodecenyl succinic anhydride (DSA) and 5 mol % of trimellitic acid anhydride (TMA) as polyvalent carboxylic acid components are put in a reaction vessel provided with a stirrer, a thermometer, a condenser and a nitrogen gas introduction tube and the reaction vessel is purged with dry nitrogen gas. Then, 1.0 part by weight of dibutyltin oxide with respect to a total 100 parts by weight of the monomer components is added thereto as a catalyst and the mixture is reacted under stirring for about 5 hours at about 190° C. under a nitrogen gas flow. The temperature is raised to about 240° C. to react the mixture under stirring for about 6 hours, and then the pressure inside the reaction vessel is reduced to 10.0 mmHg to react the mixture under stirring for about 0.5 hours under reduced pressure, thereby obtaining a yellow transparent amorphous polyester resin (A1). The glass transition temperature of the obtained amorphous polyester resin (A1) is 55° C.

Next, the obtained amorphous polyester resin (A1) is dispersed using a dispersing machine obtained by modifying a CAVITRON CD 1010 (manufactured by EUROTEC LIMITED) into a high temperature and high pressure type. The CAVITRON is operated at a composition ratio of 80% by weight of ion exchange water and 20% by weight of the polyester resin, while the pH is adjusted to 8.5 with ammonia, under the conditions of a rotation rate of a rotor of 60 Hz, a pressure of 5 kg/cm², and a temperature of 140° C. by heating using a heat exchanger; as a result, an amorphous polyester resin dispersion (A1) (solid content concentration: 20% by weight) is obtained.

Preparation of Crystalline Polyester Resin Particle Dispersion

Preparation of Crystalline Polyester Resin Particle Dispersion (CC1)

50 mol % of 1,9-nonanediol as a polyol component and 50 mol % of dodecane diacid as a polyvalent carboxylic acid component are put in a reaction vessel provided with a stirrer, a thermometer, a condenser and a nitrogen gas introduction tube, and the reaction vessel is purged with dry nitrogen gas. Then, 0.25 parts by weight of titanium tetrabutoxide with respect to the total 100 parts by weight of the monomer components is added thereto as a catalyst. The mixture is reacted under stirring for 3 hours at 170° C. under a nitrogen gas flow and then, the temperature is further raised to 210° C. for 1 hour and the pressure inside the reaction vessel is reduced to 3 kPa. The mixture is reacted under stirring for 13 hours under reduced pressure and thus a crystalline polyester resin (CC1) is obtained. The melting temperature of the obtained crystalline polyester resin (CC1) by DSC is 74° C.

Next, 300 parts by weight of the crystalline polyester resin (CC1), 160 parts by weight of methyl ethyl ketone, and 100 parts by weight of isopropyl alcohol are put in a jacketed 3-liter reaction vessel (BJ-30N, manufactured by Tokyo Rikakikai Co., Ltd.) provided with a condenser, a thermometer, a water-dropping device and an anchor blade, and while keeping the reaction vessel at 70° C. by a water circulating thermostat, the resin is dissolved by stirring and mixing the mixture at 100 rpm. Then, the stirring rotation rate is changed to 150 rpm, the water circulating thermostat is set to 66° C., and 17 parts by weight of a 10% ammonia water (reagent) is put into the vessel over 10 minutes. Thereafter, ion exchange water kept warm at 66° C. is added dropwise in an amount of 900 parts in total at a rate of 7 parts by weight per minute to cause phase inversion, thereby obtaining an emulsion liquid. 800 parts by weight of the obtained emulsion liquid and 700 parts by weight of ion exchange water are put in a 2-liter eggplant type flask, and the mixture is set to an evaporator (manufactured by Tokyo Rikakikai Co., Ltd.) provided with a vacuum control unit via a trap ball. The eggplant type flask is heated to 60° C. in a hot water bath while rotating and the pressure is reduced to 7 kPa while paying attention such that bumping does not occur, thereby removing the solvent. At a point in time when the amount of solvent collected reaches 1,100 parts by weight, the pressure is returned to atmospheric pressure, and the eggplant type flask is cooled with water to obtain a dispersion. A volume average particle size D50v of the resin particles in the dispersion is 130 nm. Thereafter, ion exchange water is added to obtain a crystalline polyester resin particle dispersion (CC1) having a solid content concentration of 20% by weight.

Preparation of Crystalline Polyester Resin Particle Dispersion (CC2)

A crystalline polyester resin particle dispersion (CC2) having a solid content concentration of 20% by weight is obtained in the same procedure as in the preparation of the crystalline polyester resin particle dispersion (CC1) except that 50 mol % of 1,9-nonanediol is changed to 50 mol % of 1,6-hexanediol.

Preparation of Crystalline Polyester Resin Particle Dispersion (CC3)

A crystalline polyester resin particle dispersion (CC3) having a solid content concentration of 20% by weight is obtained in the same procedure as in the preparation of the crystalline polyester resin particle dispersion (CC1) except that 50 mol % of 1,9-nonanediol is changed to 50 mol % of 1,4-butanediol.

The monomer compositions of the above-prepared amorphous polyester resin (A1) and crystalline polyester resins (CC1) to (CC3) are shown in Tables 1 and 2.

TABLE 1
Amorphous polyester resin

| Polyester resin number | | | A1 |
|---|---|---|---|
| Polyvalent carboxylic acid | TPA | Mol % | 40 |
| | DSA | Mol % | 5 |
| | TMA | Mol % | 5 |
| Polyol | BPA-EO | Mol % | 10 |
| | BPA-PO | Mol % | 40 |

| | | |
|---|---|---|
| Glass transition temperature | (° C.) | 55 |

TABLE 2
Crystalline polyester resin

| Polyester resin number | | | CC1 | CC2 | CC3 |
|---|---|---|---|---|---|
| Polyvalent carboxylic | Dodecane diacid | Mol % | 50 | 50 | 50 |
| acid | | | | | |
| Polyol | 1,9-nonanediol | Mol % | 50 | 0 | 0 |
| | 1,6-hexanediol | Mol % | 0 | 50 | 0 |
| | 1,4-butanediol | Mol % | 0 | 0 | 50 |

| | | | | |
|---|---|---|---|---|
| Melting temperature | (° C.) | 74 | 73 | 74 |

Preparation of Colorant Particle Dispersion
Cyan pigment: 100 parts by weight

(C.I. Pigment Blue 15:3 (copper phthalocyanine), manufactured by Dainichiseika Color & Chemicals Mfg. Co., Ltd.)
Anionic surfactant (NEOGEN R, manufactured by Dai-ichi Kogyo Seiyaku Co., Ltd.): 15 parts by weight
Ion exchange water: 900 parts by weight

The above components are mixed, dissolved, and dispersed for 1 hour using a high pressure impact type dispersing machine, ULTIMIZER (HJP30006, manufactured by Sugino Machine Ltd.), thereby preparing a colorant particle dispersion in which colorant (cyan pigment) is dispersed. The average particle size of the colorant (cyan pigment) in the colorant particle dispersion is 0.13 μm and the solid content concentration is 25% by weight.

Preparation of Release Agent Particle Dispersion
Release agent (FNP92, manufactured by Nippon Seiro Co., Ltd.): 102 parts by weight
Anionic surfactant (NEOGEN RK, manufactured by Dai-ichi Kogyo Seiyaku Co., Ltd.): 5 parts by weight
Ion exchange water: 200 parts by weight

The above components are heated to 110° C. and dispersed using a homogenizer (ULTRA TURRAX T50, manufactured by IKA Works, Inc.) and then dispersed by a high pressure MANTON GAULIN homogenizer (manufactured by Gaulin), thereby preparing a release agent particle dispersion in which a release agent having a volume average particle size of 0.21 μm is dispersed. The solid content concentration in the release agent particle dispersion is 26% by weight.

Preparation of Dispersion of Resin Particles other than Binder Resin

Preparation of Styrene-(Meth)Acrylic Resin Particle Dispersion (1)
Styrene (manufactured by Wako Pure Chemical Industries, Ltd.): 300 parts by weight
n-Butyl acrylate (manufactured by Wako Pure Chemical Industries, Ltd.): 84 parts by weight
Dodecanethiol (manufactured by Wako Pure Chemical Industries, Ltd.): 3.0 parts by weight

To a mixture obtained by mixing and dissolving the above components, a solution in which 4.0 parts by weight of an anionic surfactant DOWFAX (manufactured by The Dow Chemical Company) is dissolved in 800 parts by weight of ion exchange water is added and the mixture is dispersed and emulsified in a flask. While the mixture is mixed and stirred gently for 10 minutes, further, 50 parts by weight of ion exchange water in which 4.0 parts by weight of ammonium persulfate is dissolved is added thereto. Next, after the flask is purged with nitrogen, the solution in the flask is heated to 65° C. in an oil bath while being stirred and the emulsion polymerization continues for 5 hours as it is. Thus, a styrene-(meth)acrylic resin particle dispersion (1) is obtained. The volume average particle size of the particles in the dispersion is 120 nm, the solid content concentration is 26% by weight, and the weight average molecular weight Mw is 50,000.

Preparation of Elastomer Particle Dispersion

Preparation of Elastomer Particle Dispersion (1)
Styrene-butadiene copolymer resin (styrene/butadiene=75/25): 120 parts by weight
Anionic surfactant NEW REX R (manufactured by NOF Corporation): 6 parts by weight
Ion exchange water: 220 parts by weight

The above components are mixed and pre-dispersed using a homogenizer (ULTRA TURRAX, manufactured by IKA Works, Inc.) for 10 minutes and then dispersed by a high pressure impact type dispersing machine, Ultimizer for 15 minutes. Thus, an elastomer particle dispersion (1) having a solid content of 26% by weight and a volume average particle size of 280 nm is obtained.

### Example 1

### Preparation of Toner Particles

Amorphous polyester resin particle dispersion (A1): 406 parts by weight
Crystalline polyester resin particle dispersion (CC2): 194 parts by weight
Styrene-(meth)acrylic resin particle dispersion (1): 83 parts by weight
Colorant particle dispersion: 80 parts by weight
Release agent particle dispersion: 104 parts by weight
Aqueous surfactant solution: 60 parts by weight
0.3M aqueous nitric acid: 77 parts by weight
Ion exchange water: 400 parts by weight

The above components are put in a round stainless steel flask and dispersed using a homogenizer (ULTRA TURRAX T50, manufactured by IKA Works, Inc.). Then, the mixture is heated to 42° C. in an oil bath for heating and kept for 30 minutes and then in a stage where it is confirmed that aggregated particles are formed, 373 parts by weight of the amorphous polyester resin particle dispersion (A1) is additionally added and further kept for 30 minutes.

Subsequently, nitrilotriacetic acid Na salt (Chelest 70 manufactured by Chubu Chelest Corporation) is added such that it accounts for 3% by weight of the total solution. Then, a 1 N aqueous sodium hydroxide solution is slowly added until the pH reaches 7.2, and the mixture is heated to 85° C. under continuous stirring and then kept for 3.0 hours. Then, the reaction product is filtered, washed with ion exchange water, and dried with a vacuum dryer to prepare toner particles (1).

When the particle size of the toner particles (1) at this time is measured by a COULTER MULTISIZER, the volume average particle size D50 is 3.78 μm and the particle size distribution index GSD is 1.22.

Preparation of Toner (1)

3 parts by weight of silica particles (silica particles obtained by a sol-gel method and having an amount of surface-treated by hexamethyldisilazane of 5% by weight and an average primary particle size of 120 nm) and 1 part by weight of silica particles (R972 (manufactured by Nippon Aerosil Co., Ltd.)) are added to 100 parts by weight of toner particles (1) and mixed for 15 minutes using a 5-liter HENSCHEL mixer at a peripheral rate of 30 m/s. Then, coarse particles are removed with a screen with an opening of 45 μm to prepare toner (1).

### Example 2

Toner (2) is prepared in the same manner as in Example 1 except that 406 parts by weight of amorphous polyester resin particle dispersion (A1) is changed to 546 parts by weight, 194 parts by weight of crystalline polyester resin particle dispersion (CC2) is changed to 187 parts by weight of crystalline polyester resin particle dispersion (CC3), and the styrene-(meth)acrylic resin particle dispersion (1) is not used.

When the particle size of toner particles (2) at this time is measured by a COULTER MULTISIZER, the volume average particle size D50 is 4.10 μm and the particle size distribution index GSD is 1.23.

### Example 3

Toner (3) is prepared in the same manner as in Example 1 except that 406 parts by weight of amorphous polyester resin particle dispersion (A1) is changed to 563 parts by weight, 194 parts by weight of crystalline polyester resin particle dispersion (CC2) is changed to 104 parts by weight of crystalline polyester resin particle dispersion (CC1), and 83 parts by weight of styrene-(meth)acrylic resin particle dispersion (1) is changed to 42 parts by weight.

When the particle size of toner particles (3) at this time is measured by a COULTER MULTISIZER, the volume average particle size D50 is 3.86 μm and the particle size distribution index GSD is 1.21.

### Example 4

Toner (4) is prepared in the same manner as in Example 1 except that 406 parts by weight of amorphous polyester resin particle dispersion (A1) is changed to 511 parts by weight, 194 parts by weight of crystalline polyester resin particle dispersion (CC2) is changed to 155 parts by weight of crystalline polyester resin particle dispersion (CC1), and 83 parts by weight of styrene-(meth)acrylic resin particle dispersion (1) is changed to 42 parts by weight of elastomer particle dispersion (1).

When the particle size of toner particles (4) at this time is measured by a COULTER MULTISIZER, the volume average particle size D50 is 4.06 μm and the particle size distribution index GSD is 1.22.

### Comparative Example 1

Toner (C1) is prepared in the same manner as in Example 1 except that 406 parts by weight of amorphous polyester resin particle dispersion (A1) is changed to 479 parts by weight, 194 parts by weight of crystalline polyester resin particle dispersion (CC2) is changed to 253 parts by weight, and styrene-(meth)acrylic resin particle dispersion (1) is not used.

When the particle size of toner particles (C1) at this time is measured by a COULTER MULTISIZER, the volume average particle size D50 is 3.96 μm and the particle size distribution index GSD is 1.24.

### Comparative Example 2

Toner (C2) is prepared in the same manner as in Example 1 except that 406 parts by weight of amorphous polyester resin particle dispersion (A1) is changed to 678 parts by weight, 194 parts by weight of crystalline polyester resin particle dispersion (CC2) is changed to 55 parts by weight of crystalline polyester resin particle dispersion (CC1), and styrene-(meth)acrylic resin particle dispersion (1) is not used.

When the particle size of toner particles (C2) at this time is measured by a COULTER MULTISIZER, the volume average particle size D50 is 3.64 μm and the particle size distribution index GSD is 1.21.

Ratios of each dispersion used in the preparation of the toner particles are shown in Table 3 below.

TABLE 3

| | | Charged amount (parts by weight) | | | | | |
|---|---|---|---|---|---|---|---|
| | | | | | | Comparative | Comparative |
| | | Example 1 | Example 2 | Example 3 | Example 4 | Example 1 | Example 2 |
| Toner number | | 1 | 2 | 3 | 4 | C1 | C2 |
| Amorphous polyester resin | A1 | 779 | 919 | 936 | 884 | 852 | 1051 |
| particle dispersion | | | | | | | |
| Crystalline polyester resin | CC1 | 0 | 0 | 104 | 0 | 0 | 55 |
| particle dispersion | CC2 | 194 | 0 | 0 | 155 | 253 | 0 |
| | CC3 | 0 | 187 | 0 | 0 | 0 | 0 |

| | | | | | | |
|---|---|---|---|---|---|---|
| Styrene-(meth)acrylic resin | 83 | 0 | 42 | 0 | 0 | 0 |
| particle dispersion | | | | | | |
| Elastomer particle dispersion | 0 | 0 | 0 | 42 | 0 | 0 |
| Colorant particle dispersion | 80 | 80 | 80 | 80 | 80 | 80 |
| Release agent particle dispersion | 104 | 104 | 104 | 104 | 104 | 104 |

Evaluation of Low Temperature Fixing Temperature and Image Deletion

Developers are prepared using respective toners obtained in each example and then evaluated as follows. The evaluation results are shown in Table 4.

Each developer is prepared as follows.

100 parts by weight of ferrite particles (manufactured by Powdertech Co., Ltd., average particle size: 50 μm) and 1.5 parts by weight of methyl methacrylate resin (manufactured by Mitsubishi Rayon Co., Ltd., weight average molecular weight: 95,000) are put in a pressuring kneader together with 500 parts by weight of toluene and mixed for 15 minutes while being stirred. Then, the mixture is mixed under reduced pressure and is heated to 70° C. to distill toluene off. Then, the resultant is cooled and classified using a sieve having an opening of 105 μm, and thus a resin-coated ferrite carrier is obtained.

The resin-coated ferrite carrier and the toners obtained in each example are respectively mixed at a ratio of 8 parts by weight of toner and 92 parts by weight of carrier using a V-blender to prepare each developer.

Evaluation of Low Temperature Fixing Temperature

The low temperature fixing temperature is evaluated as follows.

Am amount of toner applied on paper manufactured by Fuji Xerox Co., Ltd. (JD paper) is adjusted to 9.8 g/m² using a modified product (that is modified to perform fixing using an external fixing device in which a fixing temperature is variable) of a DOCUCENTRE-IV C4300 (manufactured by Fuji Xerox Co., Ltd.) to form a solid toner image under the environment of 25° C. and 55% RH. After the toner image is formed, the toner image is fixed using a free belt nip fuser type external fixing device under a nip of 6.5 mm and at a fixing rate of 150 mm/sec. When the toner image is fixed, the fixing temperature is changed at an interval of 5° C. and the low temperature fixability is evaluated from a temperature at which offset on a low temperature side occurs based on the following criteria.

Evaluation Criteria

A: 150° C. or lower

B: Higher than 150° C. and 170° C. or lower

C: Higher than 170° C. and difficulty in low temperature fixability

The occurrence of offset on the low temperature side is determined based on whether or not a practical problem occurs.

Evaluation of Image Deletion

The image deletion is evaluated as follows.

A halftone image having an image density of 50% is output onto A4 paper (manufactured by Fuji Xerox Co., Ltd.) using a modified product of a copying machine DOCUCENTRE C400 (manufactured by Fuji Xerox Co., Ltd.).

The image is output under the environment of 25° C. and 50% RH.

Evaluation Criteria of Image Deletion

A: The average number of image deletion portions per A4 halftone image is 0 to 3.

B: The average number of image deletion portions per A4 halftone image is 4 to 10.

C: The average number of image deletion portions per A4 halftone image is 11 or more.

TABLE 4

| | | | | | Comparative | Comparative |
|---|---|---|---|---|---|---|
| | Example 1 | Example 2 | Example 3 | Example 4 | Example 1 | Example 2 |
| Toner number | 1 | 2 | 3 | 4 | C1 | C2 |

| | | | | | | | | |
|---|---|---|---|---|---|---|---|---|
| Composition in | Amorphous polyester resin | A1 | 72 | 83 | 85.5 | 81 | 77 | 95 |
| Toner particle | Crystalline polyester resin | CC1 | 0 | 0 | 9.5 | 14 | 0 | 5 |
| (% by weight) | | CC2 | 18 | 0 | 0 | 0 | 23 | 0 |
| | | CC3 | 0 | 17 | 0 | 0 | 0 | 0 |

| | | | | | | | |
|---|---|---|---|---|---|---|---|
| | Styrene-(meth)acrylic resin particles | 10 | 0 | 5 | 0 | 0 | 0 |
| | Elastomer particles | 0 | 0 | 0 | 5 | 0 | 0 |
| Evaluation | Young's modulus (20° C.) (GPa) | 3.3 | 3.1 | 3.4 | 3.3 | 2.8 | 3.7 |
| | Vickers hardness (20° C.) (GPa) | 0.16 | 0.13 | 0.17 | 0.25 | 0.09 | 0.24 |
| | Evaluation of low temperature | A | A | B | B | A | C |
| | fixing temperature | | | | | | |
| | Evaluation of image deletion | A | B | A | B | C | A |

From the above results, it is found that the number of image deletion portions is small while low temperature fixability is attained in Examples, compared to Comparative Examples.

Further, it is found that the number of image deletion portion is small in Examples 1 to 3 in which the Young's modulus is from 3.0 GPa to 3.5 GPa and the Vickers hardness is from 0.1 GPa to 0.2 GPa, compared to Example 4 in which the Vickers hardness is 0.25 GPa.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
a toner particle including a binder resin containing an amorphous polyester resin and a crystalline polyester resin,
wherein a Young's modulus of the toner particles at 20° C. is 3.0 GPa to 3.5 GPa.

2. The electrostatic charge image developing toner according to claim 1,
wherein a Vickers hardness of the toner particles at 20° C. is 0.1 GPa to 0.2 GPa.

3. The electrostatic charge image developing toner according to claim 1,
wherein a weight ratio of the amorphous polyester resin and the crystalline polyester resin is 1:19 to 1:4.

4. The electrostatic charge image developing toner according to claim 1,
wherein the crystalline polyester resin is formed with monomer components containing 80 mol % or more of an aliphatic polyvalent carboxylic acid having 6 to 20 carbon atoms including carbon of a carboxyl group with respect to a total amount of the polyvalent carboxylic acid, and 80 mol % or more of an aliphatic diol having 4 to 18 carbon atoms with respect to a total amount of the polyol.

5. The electrostatic charge image developing toner according to claim 1,
wherein the toner particle contains resin particles other than the binder resin.

6. The electrostatic charge image developing toner according to claim 5,
wherein the resin particles are selected from vinyl resins or polyester resins.

7. The electrostatic charge image developing toner according to claim 5,
wherein a content of the resin particles is from 2% by weight to 20% by weight with respect to a total amount of the toner particles.

8. The electrostatic charge image developing toner according to claim 1,
wherein the toner particle contains elastomer particles.

9. The electrostatic charge image developing toner according to claim 8,
wherein a content of the elastomer particles is from 0% by weight to 25% by weight with respect to a total amount of the toner particles.

10. An electrostatic charge image developer comprising:
the electrostatic charge image developing toner according to claim 1; and
an electrostatic charge image developing carrier.

11. A toner cartridge comprising:
a container that accommodates the electrostatic charge image developing toner according to claim 1 and is detachable from an image forming apparatus.

12. A process cartridge comprising:
a developing unit that accommodates the electrostatic charge image developer according to claim 10 and develops an electrostatic charge image formed on a surface of an image holding member as a toner image with the electrostatic charge image developer, wherein the process cartridge is detachable from an image forming apparatus.

13. An image forming apparatus comprising:
an image holding member;
a charging unit that charges a surface of the image holding member;
an electrostatic charge image forming unit that forms an electrostatic charge image on a charged surface of the image holding member;
a developing unit that accommodates the electrostatic charge image developer according to claim 10 and develops the electrostatic charge image formed on the surface of the image holding member as a toner image with the electrostatic charge image developer;
a transfer unit that transfers the toner image formed on the surface of the image holding member onto a surface of a recording medium; and
a fixing unit that fixes the toner image transferred onto the surface of the recording medium.
